(19) United States
(12) Patent Application Publication
(10) Pub. No.: US 2022/0086415 A1
(43) Pub. Date: Mar. 17, 2022

(54) PARALLAX CORRECTION METHOD AND DEVICE, AND STORAGE MEDIUM

(71) Applicant: SHENZHEN SENSETIME TECHNOLOGY CO., LTD., Shenzhen (CN)

(72) Inventors: Zhefeng GAO, Shenzhen (CN); Ruodai LI, Shenzhen (CN); Kun MA, Shenzhen (CN); Nanqing ZHUANG, Shenzhen (CN)

(21) Appl. No.: 17/533,988

(22) Filed: Nov. 23, 2021

Related U.S. Application Data
(63) Continuation of application No. PCT/CN2020/109547, filed on Aug. 17, 2020.

(30) Foreign Application Priority Data
Jan. 19, 2020 (CN) 202010062754.5

(51) Int. Cl. H04N 13/128; H04N 13/239

(52) U.S. Cl. CPC H04N 13/128; H04N 2213/002; H04N 13/239

(57) ABSTRACT

A parallax correction method and device, and a storage medium. The method comprises: collecting two original images comprising a target object by means of a binocular camera; determining a first paralax of the target object in imaging areas of the two original images; adjusting the positions of the imaging areas in the two original images according to the first parallax and a preset parallax; and determining a target image on the basis of the imaging areas after position adjustment.

### CROSS-REFERENCE TO RELATED APPLICATION

This is a continuation of International Application No. PCT/CN2020/109547 filed on Aug. 17, 2020, which claims priority to Chinese patent application No. 202010062754.5, filed to the National Intellectual Property Administration, PRC on Jan. 19. 2020, and entitled “Method and Device for Parallax Correction, and Storage Medium”. The contents of these applications are incorporated herein by reference in their entireties.

### BACKGROUND

At present, due to differences in the packaging process of a binocular photographing device, a little deviation in any image acquisition device in the binocular photographing device may lead to irregularity of an imaging position offset of the same object.

### SUMMARY

The disclosure relates to the field of image processing, and in particular to a method and device for parallax correction, and a storage medium.

According to the disclosure, provided is a method for parallax correction, applied to a binocular photographing device, and including: acquiring, by the binocular photographing device, two original images both containing a target object; determining a first parallax of the target object in imaging areas, each in a respective one of the two original images; adjusting positions of the imaging are in the two original images according to the first parallax and a preset parallax; and determining target images based on the imaging areas having the adjusted positions.

In the disclosure, provided is a device for parallax correction, including: an acquisition module, configured to acquire, by is binocular photographing device, two original images both containing a target object; a first parallax determination module, configured to determine a first parallax of the target object in imaging areas, each in a respective one of the two original images; a position adjustment module, configured to adjust positions of the imaging areas in the two original images according to the first parallax and a preset parallax; and a target image determination module, configured to determine target images based on the imaging areas having the adjusted positions.

According the disclosure, provided is a non-transitory computer-readable storage medium having stored thereon a computer program which is configured to perform any above method for parallax correction, the method including: acquiring, by the binocular photographing device, two original images both containing a target object; determining a first parallax of the target object in imaging areas, each in a respective one of the two original images; adjusting positions of the imaging areas in the two original images according to the first parallax and a preset parallax; and determining target images based on the imaging areas having the adjusted positions.

According the disclosure, provided is a device for parallax correction, including: a processor and a memory for storing instructions executable for the processor, wherein the processor is configured to call the executable instructions stored in the memory to: acquire, by a binocular photographing device, two original images both containing a target object; determine a first parallax of the target object in imaging areas, each in a respective one of the two original images; adjust positions of the imaging areas in the two original images according to the first parallax and a preset parallax; and determine target images based on the imaging areas having the adjusted positions.

In the disclosure, also provided is a computer program that, when executed by the processor, implements any above method for parallax correction in the first aspect.

It should be understood that the above general descriptions and detailed descriptions below are only exemplary and explanatory and not intended to limit the disclosure.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 illustrates a flowchart of a method for parallax correction according to an exemplary embodiment of the disclosure.

FIG. 2A illustrates a schematic diagram of an imaging area according to an exemplary embodiment of the disclosure.

FIG. 2B illustrates a schematic diagram of a scenario where an imaging area is moved according to an exemplary embodiment of the disclosure.

FIG. 3 illustrates a flowchart of another method for parallax correction according to an exemplary embodiment of the disclosure.

FIG. 4 illustrates a schematic diagram of a scenario where a coordinate value of a target pixel is determined according to an exemplary embodiment of the disclosure.

FIG. 5 illustrates a schematic diagram of another scenario where a coordinate value of a target pixel is determined according to an exemplary embodiment of the disclosure.

FIG. 6 illustrates a flowchart of another method for parallax correction according to an exemplary embodiment of the disclosure.

FIG. 7 illustrates a flowchart of another method for parallax correction according to an exemplary embodiment of the disclosure.

FIG. 8A illustrates a schematic diagram of a scenario before the positions of imaging areas are adjusted according to an exemplary embodiment of the disclosure.

FIG. 8B illustrates a schematic diagram of a scenario after the positions of the imaging areas are adjusted according to an exemplary embodiment of the disclosure.

FIG. 9 illustrates a flowchart of another method for parallax correction according to an exemplary embodiment of the disclosure.

FIG. 10 illustrates a flowchart of another method for parallax correction according to an exemplary embodiment of the disclosure.

FIG. 11 illustrates a block diagram of a device for parallax correction according to an exemplary embodiment of the disclosure.

FIG. 12 illustrates a schematic structural diagram of a device for parallax correction according to an exemplary embodiment of the disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise indicated. The implementations described in the following description of exemplary embodiments do not represent all implementations consistent with the disclosure. Instead, they are merely examples of devices and methods consistent with some aspects related to the disclosure as recited in the appended claims.

The terms used in the disclosure are for the purpose of describing particular embodiments only and are not intended to limit the disclosure. “A/an”, “said” and “the” in a singular form in the disclosure and the appended claims are also intended to include a plural form, unless other meanings are clearly indicated in the context. It is also to be understood that the term “and/or” as used herein refers to and includes any or all possible combinations of one or more of the associated listed items.

It is to be understood that, although terms “first”, “second”, “third” and the like may be used to describe various information in the disclosure, the information should not be limited by these terms. These terms are only used to distinguish the information of the same type. For example, without departing from the scope of the disclosure, “first information” may also be referred to as “second information” and, similarly “second information” may also be referred to as “first information”. For example, term “if” as used here may be explained as “while” or “when” or “in response to determining that”, which depends on the context.

A method and device for parallax correction, and a storage medium, which may be applied to a binocular photographing device are provided in the disclosure. During parallax correction, there is no need to calibrate the binocular photographing device, instead the positions of imaging areas in two original images are adjusted according to a first parallax of a target object in the imaging areas of the two original images and a preset parallax, thereby improving the consistency in imaging of the binocular photographing device without adding extra cost and computation burden.

It is to be noted that the technical solution in which a Red Green Blue (RGB) camera and an Infra-Red (IR) camera (or at least two RGB cameras or at least two IR cameras) are purely used instead of the binocular photographing device in the disclosure, or the binocular photographing device is extended to be a trinocular photographing device, a multi-nocular photographing device, etc., and the method for parallax correction provided in the disclosure is used to improve the consistency in imaging of the photographing device by adjusting a position of an imaging area shall also fall within the protection scope of the disclosure.

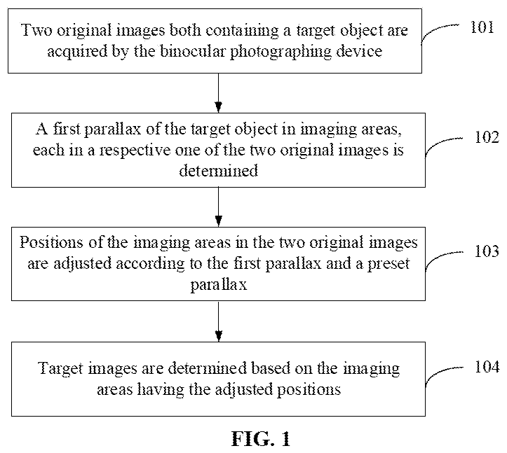

As illustrated in FIG. 1 of a method for parallax correction according to an exemplary embodiment. The method may include the following actions.

At S101, two original images both containing a target object are acquired through a binocular photographing device.

In some embodiments of the disclosure, the target object may be any object, such as a face and a checkerboard. Each image acquisition device contained in the binocular photographing device may acquire an original image, so as to obtain two original images. The image acquisition device may be a camera. One camera may be an RGB camera (an ordinary optical camera), and the other camera may be an IR camera. Of course, the two cameras may both be RGB cameras, or may both be IR cameras, which is not limited in the disclosure.

At S102, a first parallax of the target object in imaging areas, each in a respective one of the two original images is determined.

In some embodiments of the disclosure, if an image obtained by cutting and/or scaling an original image acquired by the image acquisition device is directly taken as a target image output by the image acquisition device, a corresponding Field of View (FOV) of the image acquisition device will be greatly affected. The magnitude of the FOV decides a visual field range of the image acquisition device. In order to avoid narrowing the visual field of the image acquisition device while parallax correction is performed, an image corresponding to an imaging area may be cut from the original image, and a final target image output by the image acquisition device may be obtained by scaling the image corresponding to the imaging area.

In some embodiments of the disclosure, the imaging area is cut from the original image and is used to generate the output of the image acquisition device. Before the position of the imaging area is adjusted, the imaging area corresponding to each image acquisition device is right in the middle of the original image acquired by the image acquisition device by default.

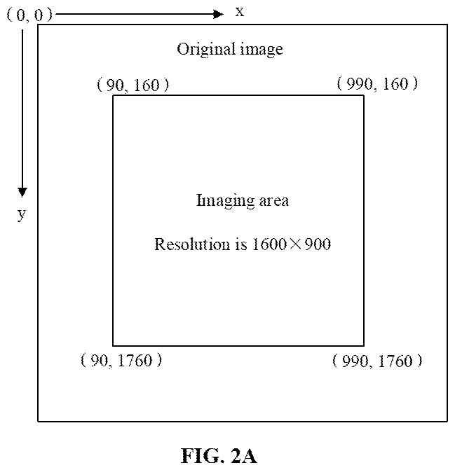

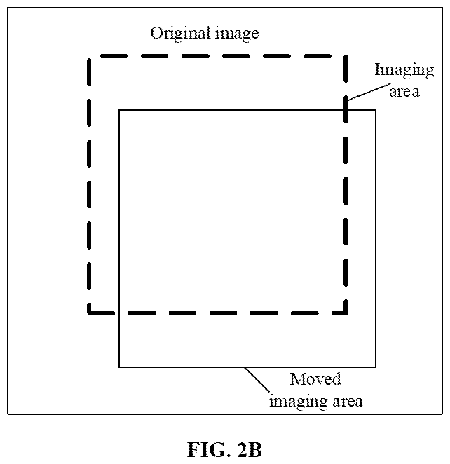

For example, as illustrated in FIG. 2A, the resolution of the original image acquired by each image acquisition device included in the binocular photographing device is the same, which is 1920×1080. The resolution of the imaging area may be 1600×900. Taking the position of a pixel corresponding to the vertex at the upper left corner of the original image as the origin of coordinates, before the position of the imaging area is adjusted, coordinate values of the pixels in the original image corresponding to the vertex at the upper left corner, the vertex at the upper right corner, the vertex at the lower left corner and the vertex at the lower right corner of the imaging area in the original image are (90, 160), (990, 160), (90, 1760) and (990, 1760) respectively.

The first parallax is a parallax of the same target object in the imaging areas of two original images. The first parallax may include a horizontal parallax and a vertical parallax.

At S103, positions of the imaging areas in the two original images are adjusted according to the first parallax and a preset parallax.

The preset parallax may be an ideal parallax of a preset target object that can be achieved in imaging areas of two original images acquired by two image acquisition devices. The preset parallax may also include a horizontal parallax and a vertical parallax. In some embodiments of the disclosure, the vertical parallax in the preset parallax may be 0, and the horizontal parallax in the preset parallax may be a preset value.

For example, the position of an imaging area that is not adjusted is as illustrated in FIG. 2A, and the imaging area having an adjusted position may be as illustrated in FIG. 2B.

At S104, target images are determined based on the imaging areas having the adjusted positions.

In some embodiments of the disclosure, the image corresponding to the imaging area may be scaled to obtain the target image corresponding to each image acquisition device.

In some embodiments, if the resolution of the image corresponding to the imaging area is 1600×900, then a target image with a resolution of 1280×720 may be obtained by downsampling the pixels contained in the image corresponding to the imaging area. Alternatively, if the resolution of the target image is greater than the resolution of the image corresponding to the imaging area, then the target image with a higher resolution may be obtained by upsampling or performing image interpolation on the pixels contained in the image corresponding to the imaging area.

In above embodiment, two original images both containing a target object may be acquired through a binocular photographing device, so as to determine a first parallax of the target object in imaging areas of the two original images. Positions of the imaging areas in the two original images are adjusted according to the first parallax and a preset parallax, so that target images are determined based on the adjusted imaging areas. In the disclosure, the parallax of the binocular photographing device can be corrected, thereby avoiding extra computation burden caused by calibrating the binocular photographing device to correct the parallax, and improving the consistency in imaging of the binocular photographing device.

It is to be noted that although it is limited in the disclosure that both the positions of the imaging areas may be adjusted, the solution in which the purpose of parallax correction is achieved by keeping the position of one imaging area unchanged while adjusting the position of the other imaging area shall also fall within the protection scope of the disclosure.

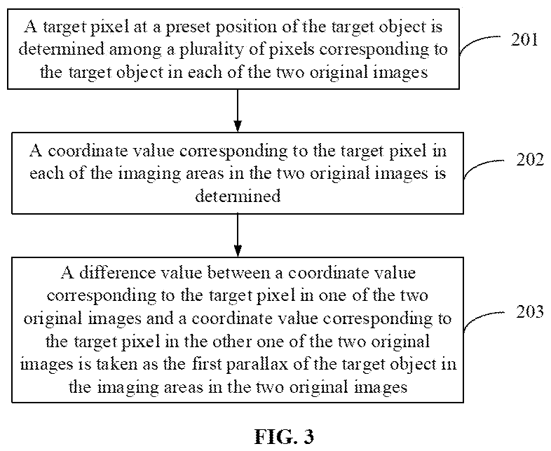

In some embodiments, as illustrated in FIG. 3, S102 may include the following actions S201, S202 and S203.

At S201, a target pixel at a preset position of the target object is determined among a plurality of pixels corresponding to the target object in each of the two original images.

In some embodiments of the disclosure, the preset position may be any position on the target object. For example, the preset position may be the left-most position, the right-most position or the central position on the target object. With the target object being a checkerboard as an example, the target pixel may be the pixel at the central position of the checkerboard on each of the two original images.

At S202, a coordinate value corresponding to the target pixel in each of the imaging areas in the two original images is determined.

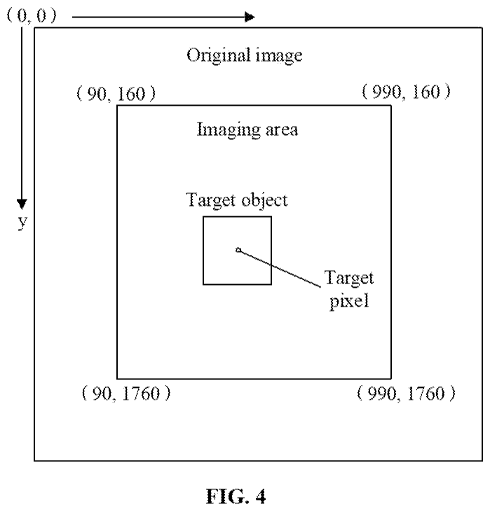

In some embodiments of the disclosure, any position in the imaging area may be taken as the origin of coordinates. For example, the pixel corresponding to the vertex at the upper left corner of the imaging area is taken as the origin of coordinates, and the horizontal and vertical coordinate value of the target pixel in the coordinate system is determined, as illustrated in FIG. 4.

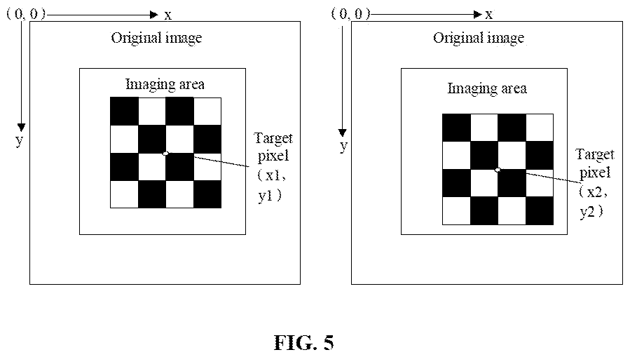

With the target object being a checkerboard as an example, the checkerboard may be any checkerboard such as a 3×3 checkerboard and a 9×9 checkerboard. For example, as illustrated in FIG. 5, the target pixel is the pixel corresponding to the central position of the checkerboard, and the pixel corresponding to the vertex at the upper left corner of the imaging area in the original image is taken as the origin of coordinates in both the two original images. The coordinate values (x₁, y₁) corresponding to the target pixel is determined in the imaging area in one of the two original images, and the coordinate value (x₂, y₂) corresponding to the target pixel is determined in the imaging area in the other one of the two original images.

At S203, a difference value between a coordinate value corresponding to the target pixel in the imaging area in one of the two original images and a coordinate value corresponding to the target pixel in the imaging area in the other one of the two original images is taken as the first parallax of the target object in the imaging areas in the two original images.

In some embodiments of the disclosure, the first parallax includes a horizontal parallax and a vertical parallax. The horizontal parallax may be a difference value between the horizontal coordinate values of the target pixel, for example, x₁−x², and the vertical parallax may be a difference value between the vertical coordinate values of the target pixel, for example, y₁−y₂.

In above embodiment, the target pixel at the preset position of the target object may be determined among a plurality of pixels corresponding to the target object in each original image, so that the coordinate value corresponding to the target pixel is determined in the imaging area in each original image. The difference value between the coordinate value corresponding to the target pixel in the imaging area in one of the original images and the coordinate value corresponding to the target pixel in the imaging area in the other original image is taken as the first parallax of the target object in the imaging areas of the two original images. Through the above process, the first parallax of the target object in the imaging areas of the two original images may be determined, which is easy to realize, and high availability is achieved.

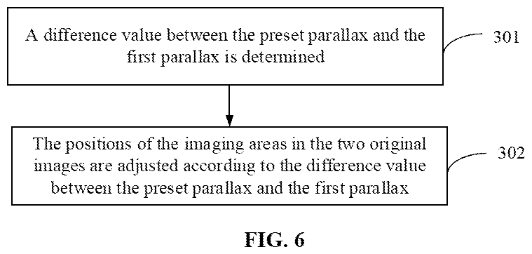

In some embodiments, as illustrated in FIG. 6, S103 may include the following actions S301 and S302.

At S301, a difference value between the preset parallax and the first parallax is determined.

In some embodiments of the disclosure, if the horizontal parallax contained the preset parallax is a preset value, and the vertical parallax contained in the preset parallax is 0, then the difference value between the preset parallax and the first parallax includes a first difference value in the horizontal direction and a second difference value in the vertical direction. The first difference value is (the preset value−(x₁−x₂)), and the second difference value is (0−(y₁−y₂)).

At S302, the positions of the imaging areas in the two original images are adjusted according to the difference value.

In above embodiment, the difference value between the preset parallax and the first parallax may be determined, so that the positions of the imaging areas in the two original images are adjusted according to the difference value, thereby avoiding extra computation burden caused by calibrating the binocular photographing device to collect the parallax, and improving the consistency in imaging of the binocular photographing device.

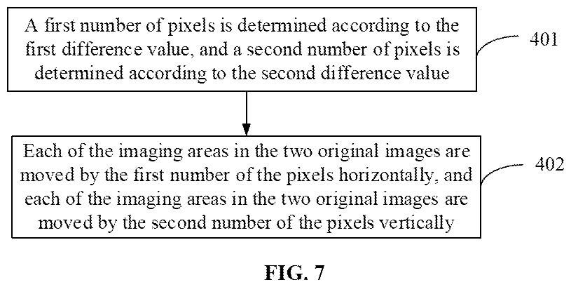

In some embodiments, as illustrated in FIG. 7, S302 may include the following actions S401 and S402.

At S401, a first number of pixels is determined according to the first difference value, and a second number of pixels is determined according to the second difference value.

According to some embodiments of the disclosure, in an implementation, a half of an absolute value of the first difference value may be taken as the first number of pixels. Similarly, a half of the absolute value of the second difference value may be taken as the second number of pixels.

In another implementation, the absolute value of the first difference value may also be directly taken as the first number of pixels, and the absolute value of the second difference value may be taken as the second number of pixels.

If the position of one imaging area is to be kept unchanged and the other imaging area is to be moved, then the other imaging area needs to be horizontally moved by the number of pixels which is the absolute value of the first difference value, and needs to be vertically moved by the number of pixels which is the absolute value of the second difference value.

Any other solutions in which the sum of the numbers of pixels by which the two imaging areas are moved horizontally is the first difference value, and the sum of the numbers of pixels by which the two imaging areas are moved vertically is the second difference value shall fall within the protection scope of the disclosure.

At S402, each of the imaging areas in the two original images is moved by the first number of pixels horizontally, and is moved by the second number of pixels vertically.

In some embodiments of the disclosure, in order to avoid a situation where only the imaging area in one original image is moved so that the imaging area is moved out of the range of the original image, the imaging areas in the two original images may both be horizontally moved by the same first number of pixels towards each other or away from each other, and vertically moved by the same second number of pixels towards each other or away from each other.

Of course, if it is determined that an imaging area will not be moved out of the range of the original image even if only the imaging area is moved, the position of one imaging area may be kept unchanged and the other imaging area may be moved. In this case, the first number of pixels by which the other imaging area needs to be moved horizontally is the absolute value of the first difference value, and the second number of pixels by which the other imaging area needs to be moved vertically is the absolute value of the second difference value.

Any other solutions in which the stun of the numbers of pixels by which the two imaging areas are moved horizontally is the first difference value, and the sum of the numbers of pixels by which the two imaging areas are moved vertically is the second difference value shall fall within the protection scope of the disclosure.

In above embodiment, the first number of pixels may be determined according to the first difference value between the first parallax and the preset parallax in the horizontal direction, and the second number of pixels may be determined according to the second difference value between the first parallax and the preset parallax in the vertical direction. Each of the imaging areas in the two original images are moved by the first number of pixels horizontally and by the second number of pixels vertically. By adjusting the positions of the imaging areas in the two original images in the above way, the position adjusting process is more reasonable and the consistency in imaging of the binocular photographing device is improved.

In some embodiments, in response to that the first difference value is greater than 0, it indicates that the horizontal parallax of the target object in the imaging areas of the two image acquisition devices is too large. In this case, the imaging area in one of the original images may be horizontally moved by the first number of pixels in a first direction towards the imaging area in the other one of the original images, and the imaging area in the other one of the original images may be horizontally moved by the first number of pixels in a direction opposite to the first direction, thereby reducing the horizontal parallax of the target object in the imaging areas of the two image acquisition devices. For example, the first direction is rightward, and the direction opposite to the first direction is leftward.

In response to that the first difference value is less than 0, it indicates that the horizontal parallax of the target object in the imaging areas of the two image acquisition devices is too small. In this case, the imaging area, in the one of the original images may be horizontally moved by the tint number of pixels in the second direction away from the imaging area in the other one of the original images, and the imaging area in the other original image may be horizontally moved by the first number of pixels in a direction opposite to the second direction, thereby increasing the horizontal parallax of the target object in the imaging areas of the two image acquisition devices. For example, the second direction is leftward, and the direction opposite to the second direction is rightward.

Likewise, in response to that the second difference value is greater than 0, it indicates that the vertical parallax of the target object in the imaging areas of the two image acquisition devices is too large. In this case, the imaging area in the one of the original images may be vertically moved by the second number of pixels in a third direction towards the imaging area in the other one of the original images, and the imaging area in the other original image may be vertically moved by the second number of pixels in a direction opposite to the third direction, thereby reducing the vertical parallax of the target object in the imaging areas of the two image acquisition devices. For example, the third direction is downward, and the direction opposite to the third direction is upward.

In response to that the second difference value is less than 0, it indicates that the vertical parallax of the target object in the imaging areas of the two image acquisition devices is too small. In this case, the imaging area in the one of the original images may be vertically moved by the second number of pixels in the fourth direction away from the imaging area in the other one of the original images, and the imaging area in the other original image may be vertically moved by the second number of pixels in a direction opposite to the fourth direction, thereby increasing the vertical parallax of the target object in the imaging areas of the two image acquisition devices. For example, the fourth direction is upward, and the direction opposite to the fourth direction is downward.

An example is given below to describe the above method for parallax correction.

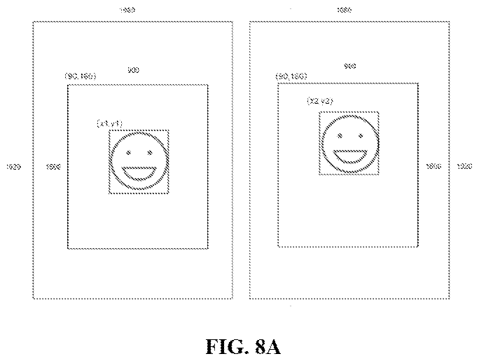

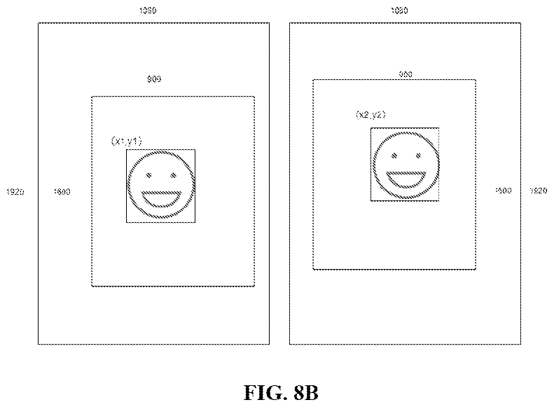

The target object is a face. The binocular photographing device includes an IR image acquisition device and an RGB image acquisition device. Two original images containing the face acquired by the binocular photographing device are as illustrated in FIG. 8A, and the resolution of the two original images is 1920×1080.

Before parallax correction is performed, the imaging area is right in the middle of the original image, and the coordinate value of the pixel corresponding to the vertex at the upper left corner of the imaging area is (90, 160) in the original images. Assuming that the pixel corresponding to the central position of the face is the target pixel, and two sets of coordinate values of the target pixels in the two imaging areas are (100, 100) and (150, 60) respectively, it may be determined that the first parallax includes the horizontal parallax of 50, and the vertical parallax of −40.

If the preset parallax includes the horizontal parallax with a preset value A which is 100, and the vertical parallax of 0, then it may be determined that the first difference value is 100−50=50, and the second difference value is 0−(−40)=40. The first number of pixels is determined as 25 according to the first difference value, and the second number of pixels is determined as according to the second difference value.

Because the first difference value is greater than 0, the imaging areas in the two original images need to be horizontally moved towards each other. Because the second difference value is also greater than 0, the imaging areas in the two original images also need to be vertically moved towards each other. The first number of pixels for the movement is 25, and the second number of pixels for the movement is 20. Then the imaging areas in FIG. 8A are adjusted to obtain the imaging areas in FIG. 8B respectively. The imaging area on the left is horizontally moved by 25 pixels rightwards and is vertically moved by 20 pixels upwards. The imaging area on the right is horizontally moved by 25 pixels leftwards and is vertically moved by 20 pixels downwards.

It can be seen that by adjusting the positions of the imaging areas, the horizontal parallax of the target object in the two imaging areas may reach the preset value A, and the vertical parallax of the target object in the two imaging areas may be 0.

In above embodiment, by adjusting the positions of the imaging areas in the two original images acquired by the binocular photographing device, the purpose of parallax correction is achieved. Extra computation burden caused by calibrating the binocular photographing device to correct the parallax is avoided, and the consistency in imaging of the binocular photographing device is improved.

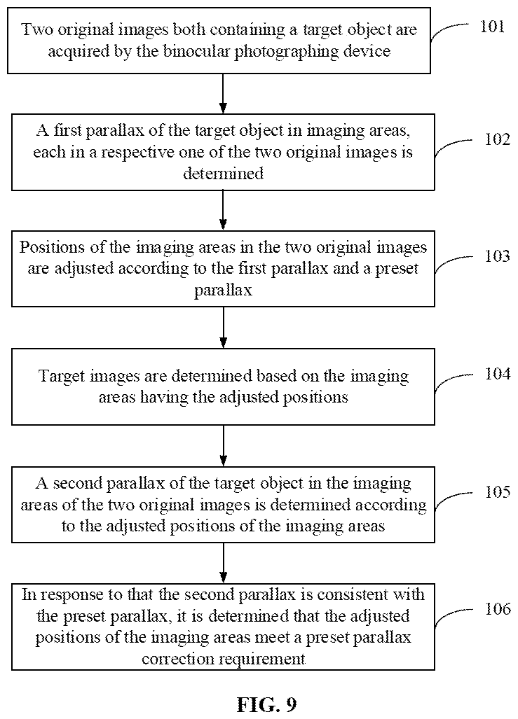

In some embodiments, as illustrated in FIG. 9, after S104, the above method may further include the following actions.

At S105, a second parallax of the target object in the imaging areas of the two original images is determined according to the adjusted positions of the imaging areas.

In some embodiments of the disclosure, the second parallax may be determined in the same way as that of determining the first parallax in the imaging areas of the two original images described above, which will not be repeated here. Because the position of the imaging area corresponding to each image acquisition device is adjusted, the value of the second parallax is different from that of the first parallax.

At S106, in response to that the second parallax is consistent with the preset parallax, it is determined that the adjusted positions of the imaging areas meet a preset parallax correction requirement.

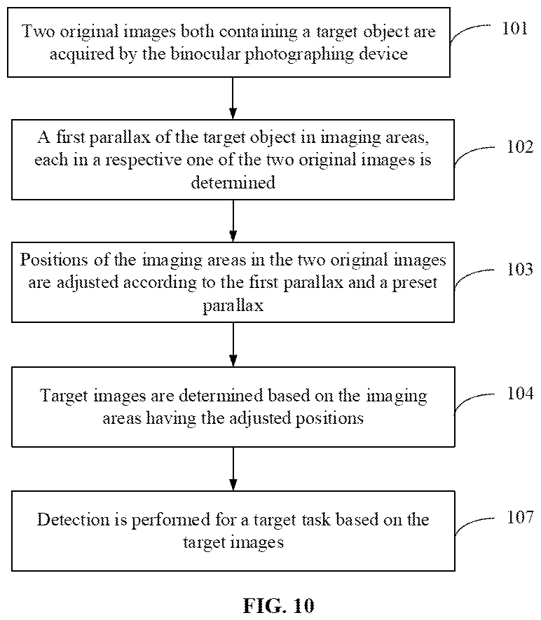

In above embodiment, whether the parallax of the target object in the adjusted imaging areas is consistent with the preset parallax is determined through the second parallax determined again, so as to determine whether position information of the adjusted imaging areas conforms to a preset parallax correction requirement. The accuracy of parallax correction is improved. In some embodiments, as illustrated in FIG. 10, after S104, the method may further include the following actions.

At S107, detection is performed for a target task based on the target images.

Because the positions of the imaging areas are already adjusted according to the difference value between the first parallax and the preset parallax, the parallax of the target object in the imaging areas of the two original images should be the preset parallax. That is, the horizontal parallax is the preset value, and there is no vertical parallax. In this case, performing detection for the target task according to the target images may improve the accuracy of detection for the target task. The target task may be living object detection and other tasks.

In above embodiment, after the target images are determined, detection may be performed for the target task based on the target images, which achieves high availability and improves the accuracy of detection for the target detection.

Corresponding to the above method embodiments, device embodiments are also provided in the disclosure.

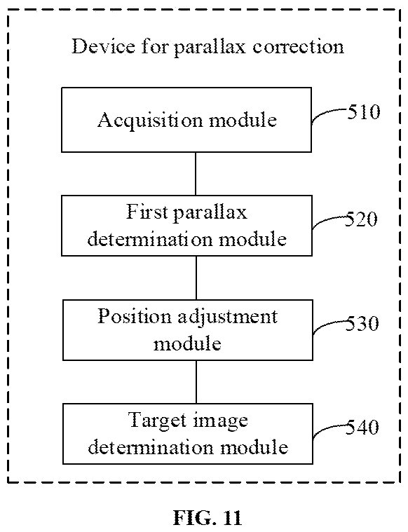

As illustrated in FIG. 11 of a block diagram of a device for parallax correction according to an exemplary embodiment of the disclosure. The device includes: an acquisition module 510, configured to acquire, by a binocular photographing device, two original images both containing a target object, a first parallax determination module 520, configured to determine a first parallax of the target object in imaging areas, each in a respective one of the two original images; a position adjustment module 530, configured to adjust positions of the imaging areas in the two original images according to the first parallax and a preset parallax; and a target image determination module 540, configured to determine target images based on the imaging areas having the adjusted positions.

In some embodiments, the first parallax determination module 520 includes: a first determination submodule, configured to determine a target pixel at a preset position of the target object among a plurality of pixels corresponding to the target object in each of the two original images; a second determination submodule, configured to determine a coordinate value corresponding to the target pixel in each of the imaging areas in the two original images; and a third determination submodule, configured to take a difference value between a coordinate value corresponding to the target pixel in the imaging area in one of the two original images and a coordinate value corresponding to the target pixel in the imaging area in the other one of the two original images as the first parallax of the target object in the imaging areas in the two original images.

In some embodiments, the position adjustment module 530 includes: a fourth determination submodule, configured to determine a difference value between the preset parallax and the first parallax; and a position adjustment submodule, configured to adjust the positions of the imaging areas in the two original images according to the difference value between the preset parallax and the first parallax.

In some embodiments, the difference value between the preset parallax and the first parallax includes a first difference value in a horizontal direction and a second difference value in a vertical direction; and the position adjustment submodule includes: a first determination unit, configured to determine a first number of pixels according to the first difference value, and determine a second number of pixels according to the second difference value; and a position adjustment unit, configured to move each of the imaging areas in the two original images by the first number of pixels horizontally, and move each of the imaging areas in the two original images by the second number of pixels vertically.

In some embodiments, the first determination unit is configured to: calculate a half of an absolute value of the first difference value to obtain the first number of pixels, and calculate a half of an absolute value of the second difference value to obtain the second number of pixels.

In some embodiments, the position adjustment unit is configured to perform at least one of the following: in response to that the first difference value is greater than 0, horizontally move the imaging area in one of the two original images by the first number of pixels in a first direction towards the imaging area in the other one of the two original images, and horizontally move the imaging area in the other one of the two original images by the first number of pixels in a direction opposite to the first direction; in response to that the first difference value is less than 0, horizontally move the imaging area in the one of the two original images by the first number of pixels in a second direction away from the imaging area in the other one of the two original images, and horizontally move the imaging area in the other one of the two original images by the first number of pixels in a direction opposite to the second direction; in response to that the second difference value is greater than 0, vertically move the imaging area in the one of the two original images by the second number of pixels in a third direction towards the imaging area in the other one of the two original images, and vertically move the imaging area in the other one of the two original images by the second number of pixels in a direction opposite to the third direction; or in response to that the second difference value is less than 0, vertically move the imaging area in the one of the two original images by the second number of pixels in a fourth direction away from the imaging area in the other one of the two original images, and vertically move the imaging area in the other one of the two original images by the second number of pixels in a direction opposite to the fourth direction.

In some embodiments, the device further includes: a second parallax determination module, configured to determine a second parallax of the target object in the imaging areas of the two original images according to the adjusted positions of the imaging areas; and a parallax correction requirement determination module, configured to: in response to that the second parallax is consistent with the preset parallax, determine that the adjusted positions of the imaging areas meet a preset parallax correction requirement.

In some embodiments, the device further includes a task detection module, configured to: perform detection for a target task based on the target images.

The device embodiments substantially correspond to the method embodiments, and thus related parts may refer to description of the method embodiments. The device embodiments described above are only illustrative. Units described as separate parts therein may or may not be physically separated, and parts displayed as units may or may not be physical units. Namely they may be located in the same place or may also be distributed to multiple network units. Part or all of the modules may be selected according to a practical requirement to achieve the purpose of the solutions of the disclosure, which may be understood and implemented by those of ordinary skill in the art without creative work.

In the disclosure, also provides is a computer-readable storage medium having stored thereon a computer program that is configured to perform any above method for parallax correction.

In some embodiments, also provided is a computer program product including computer readable code that, when running in a device, causes a processor in the device to execute instructions for implementing the method for parallax correction provided in any above embodiment.

In some embodiments, also provided is another computer program product configured to store computer readable instructions that, when executed, enables a computer to perform the operations of the method for parallax correction provided in any above embodiment.

The computer program product may be specifically realized by means of hardware, software or a combination thereof. In some embodiments, the computer program product is specifically embodied as a computer storage medium, and in some other embodiments, the computer program product is specifically embodied as a software product, such as a Software Development Kit (SDK).

In some embodiments of the disclosure, also provided is a device for parallax correction, which may include: a processor, and a memory configured to store instructions executable for the processor. The processor is configured to call the executable instructions stored in the memory to implement any above method for parallax correction.

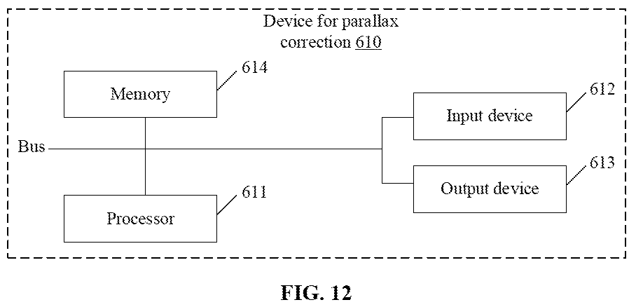

FIG. 12 illustrates a hardware structure diagram of a device for parallax correction provided in some embodiments of the disclosure. The device for parallax correction 610 may include a processor 611, and may also include an input device 612, an output device 613 and a memory 614. The input device 612, the output device 613, the memory 614 and the processor 611 are connected with each other through a bus.

The memory includes, but is not limited to, a Random Access memory (RAM), a Read-Only Memory (ROM), an Erasable Programmable Read-only Memory (EPROM), or a Compact Disc Read-Only Memory (CD-ROM). The memory is used for related instructions and data.

The input device is configured to input data and/or signal, and the output device is configured to output data and/or signal. The output device and the input device may be independent devices or an integrated device.

The processor may include one or more processors, such as one or more Central Processing Units (CPU). If the processor is a CPU, the CPU may be a single-core CPU or a multi-core CPU.

The memory is configured to store program code and data of a network device.

The processor is configured to call the program code and data in the memory to perform the actions in the above method embodiments. The details are described in the method embodiments and will not be repeated here.

It is understandable that FIG. 12 illustrates only a simplified design of the device for parallax correction. In practical applications, the device for parallax correction may also include other necessary components, which include but not limited to, any number of input/output devices, processors, controllers, memories, etc., and all the devices for parallax corrections that can implement the embodiments of the disclosure shall fall within the protection scope of the disclosure.

The technical solutions provided in the embodiments of the disclosure may have the following beneficial effects.

In the embodiments of the disclosure, two original images both containing a target object may be acquired through a binocular photographing device, so as to determine a first parallax of the target object in imaging areas of the two original images. Positions of the imaging areas in the two original images are adjusted according to the first parallax and a preset parallax, so that target images are determined based on the adjusted imaging areas. In the disclosure, the parallax of the binocular photographing device can be corrected, thereby avoiding extra computation burden caused by calibrating the binocular photographing device to correct the parallax, and improving the consistency in imaging of the binocular photographing device.

In the embodiments of the disclosure, the target pixel at the preset position of the target object may be determined among a plurality of pixels corresponding to the target object in each original image, so that the coordinate value corresponding to the target pixel is determined in the imaging area in each original image. The difference value between the coordinate value corresponding to the target pixel in the imaging area in one of the original images and the coordinate value corresponding to the target pixel in the imaging area in the other original image is taken as the first parallax of the target object in the imaging areas of the two original images. Through the above process, the first parallax of the target object in the imaging areas of the two original images may be determined, which is easy to realize, and high availability is achieved.

In the embodiments of the disclosure, the difference value between the preset parallax and the first parallax may be determined, so that the positions of the imaging areas in the two original images are adjusted according to the difference value, thereby avoiding extra computation burden caused by calibrating the binocular photographing device to correct the parallax, and improving the consistency in imaging of the binocular photograph device.

In the embodiments of the disclosure, the first number of pixels may be determined according to the first difference value between the first parallax and the preset parallax in the horizontal direction, and the second number of pixels may be determined according to the second difference value between the first parallax and the preset parallax in the vertical direction. Each of the imaging areas in the two original images are moved by the first number of pixels horizontally and by the second number of pixels vertically. By adjusting the positions of the imaging areas in the two original images in the above way, the position adjusting process is more reasonable and the consistency in imaging of the binocular photographing device is improved.

In the embodiments of the disclosure, in response to that the first difference value is greater than 0, horizontally moving the imaging area in one of the two original images by the first number of pixels in a first direction towards the imaging area in the other one of the two original images, and horizontally moving the imaging area in the other one of the two original images by the first number of pixels in a direction opposite to the first direction; in response to that the first difference value is less than 0, horizontally moving the imaging area in the one of the two original images by the first number of pixels in a second direction away from the imaging area in the other one of the two original images, and horizontally moving the imaging area in the other one of the two original images by the first number of pixels in a direction opposite to the second direction. Likewise, the positions of the imaging areas in the two original images are adjusted vertically in the similar way. The position adjusting process is more reasonable and is easy to realize, and the consistency in imaging consistency the binocular photographing device is improved.

In the embodiments of the disclosure, after the positions of the imaging areas in the two original images are adjusted, the second parallax of the target object in the imaging areas of the two original images may be determined according to the adjusted positions of the imaging areas. In response to that the second parallax is consistent with the preset parallax, it may be determined that the adjusted positions of the imaging areas meet the preset parallax correction requirement. The accuracy of parallax correction is improved.

In the embodiments of the disclosure, after the target images are determined, detection may be performed for the target task based on the target image, which has high availability and improves the accuracy of detection for the target task.

Other implementations of the disclosure will be apparent to those skilled in the art from consideration of the specification and practice of the disclosure. This disclosure is intended to cover any variations, uses, or adaptations of the disclosure following the general principles thereof and including such departures from the disclosure as come within known or customary practice in the art. It is intended that the specification and examples are considered as exemplary only, with a true scope and spirit of the disclosure being indicated by the following claims.

The above are only preferred embodiment of the disclosure and not intended to limit the disclosure. Any modifications, equivalent replacements, improvements and the like made within the spirit and principle of the disclosure shall within the scope of protection of the disclosure.

1. A method for parallax correction, applied to a binocular photographing device, and comprising:
acquiring, by the binocular photographing device, two original images both containing a target object:
determining a first parallax of the target object in imaging areas, each in a respective one of the two original images;
adjusting positions of the imaging areas in the two original images according to the first parallax and a preset parallax; and
determining target images based on the imaging areas having the adjusted positions.

2. The method of claim 1, wherein determining the first parallax of the target object in the imaging areas, each in the respective one of the two original images comprises:
determining a target pixel at a preset position of the target object among a plurality of pixels corresponding to the target object in each of the two original images;
determining a coordinate value corresponding to the target pixel in each of the imaging areas in the two original images; and
taking a difference value between a coordinate value corresponding to the target pixel in the imaging area in one of the two original images and a coordinate value corresponding to the target pixel in the imaging area in the other one of the two original images as the first parallax of the target object in the imaging areas in the two original images.

3. The method of claim 1, wherein adjusting the positions of the imaging areas in the two original images according to the first parallax and the preset parallax comprises:
determining a difference value between the preset parallax and the first parallax; and
adjusting the positions of the imaging areas in the two original images according to the difference value between the preset parallax and the first parallax.

4. The method of claim 3, wherein the difference value between the preset parallax and the first parallax comprises a first difference value in a horizontal direction and a second difference value in a vertical direction; and
adjusting the positions of the imaging areas in the two original images according to the difference value between the preset parallax and the first parallax comprises:
determining a first number of pixels according to the first difference value, and determining a second number of pixels according to the second difference value; and
moving each of the imaging areas in the two original images by the first number of pixels horizontally, and moving each of the imaging areas in the two original images by the second number of pixels vertically.

5. The method of claim 4, wherein determining the first number of pixels according to the first difference value, and determining the second number of pixels according to the second difference value comprises:
calculating a half of an absolute value of the first difference value to obtain the first number of pixels, and
calculating a half of an absolute value of the second difference value to obtain the second number of pixels.

6. The method of claim 4, wherein moving each of the imaging areas in the two original images by the first number of pixels horizontally, and moving each of the imaging areas in the two original images by the second number of pixels vertically comprises at least one of:
in response to that the first difference value is greater than 0, horizontally moving the imaging area in one of the two original images by the first number of pixels in a first direction towards the imaging area in the other one of the two original images, and horizontally moving the imaging area in the other one of the two original images by the first number of pixels in a direction opposite to the first direction;
in response to that the first difference value is less than 0, horizontally moving the imaging area in the one of the two original images by the first number of pixels in a second direction away from the imaging area in the other one of the two original images, and horizontally moving the imaging area in the other one of the two original images by the first number of pixels in a direction opposite to the second direction;
in response to that the second difference value is greater than 0, vertically moving the imaging area in the one of the two original images by the second number of pixels in a third direction towards the imaging area in the other one of the two original images, and vertically moving the imaging area in the other one of the two original images by the second number of pixels in a direction opposite to the third direction; or
in response to that the second difference value is less than 0, vertically moving the imaging area in the one of the two original images by the second number of pixels in a fourth direction away from the imaging area in the other one of the two original images, and vertically moving the imaging area in the other one of the two original images by the second number of pixels in a direction opposite to the fourth direction.

7. The method of claim 1, wherein after adjusting the positions of the imaging areas in the two original images, the method further comprises:
determining a second parallax of the target object in the imaging areas of the two original images according to the adjusted positions of the imaging areas; and
in response to that the second parallax is consistent with the preset parallax, determining that the adjusted positions of the imaging areas meet a preset parallax correction requirement.

8. The method of claim 1, wherein after determining the target images, the method further comprises:
performing detection for a target task based on the target images.

9. A device for parallax correction, comprising:
a processor; and
a memory for storing instructions executable for the processor;
wherein the processor is configured to call the executable instructions stored in the memory to:
acquire, by a binocular photographing device, two original images both containing a target object;
determine a first parallax of the target object in imaging areas, each in a respective one of the two original images;
adjust positions of the imaging areas in the two original images according to the first parallax and a preset parallax; and
determine target images based on the imaging areas having the adjusted positions.

10. The device of claim 9, wherein in determining the first parallax of the target object in the imaging areas, each in the respective one of the two original images, the processor is configured to call the executable instructions stored in the memory to:
determine a target pixel at a preset position of the target object among a plurality of pixels corresponding to the target object in each of the two original images;
determine a coordinate value corresponding to the target pixel in each of the imaging areas in the two original images; and
take a difference value between a coordinate value corresponding to the target pixel in the imaging area in one of the two original images and a coordinate value corresponding to the target pixel in the imaging area in the other one of the two original images as the first parallax of the target object in the imaging areas in the two original images.

11. The device of claim 8, wherein in adjusting the positions of the imaging areas in the two original images according to the first parallax and the preset parallax, the processor is configured to call the executable instructions stored in the memory to:
determine a difference value between the preset parallax and the first parallax; and
adjust the positions of the imaging areas in the two original images according to the difference value between the preset parallax and the first parallax.

12. The device of claim 11, wherein the difference value between the preset parallax and the first parallax comprises a first difference value in a horizontal direction and a second difference value in a vertical direction; and
in adjusting the positions of the imaging areas in the two original images according to the difference value between the preset parallax and the first parallax, the processor is configured to call the executable instructions stored in the memory to:
determine a first number of pixels according to the first difference value, and determine a second number of pixels according to the second difference value; and
move each of the imaging areas in the two original images by the first number of pixels horizontally, and move each of the imaging areas in the two original images by the second number of pixel vertically.

13. The device of claim 12, wherein in determining the first number of pixels according to the first difference value, and determining the second number of pixels according to the second difference value. the processor is configured to call the executable instructions stored in the memory to:
calculate a half of an absolute value of the first difference value to obtain the first number of pixels, and
calculate a half of an absolute value of the second difference value to obtain the second number of pixels.

14. The device of claims 12, wherein in moving each of the imaging areas in the two original images by the first number of pixels horizontally, and moving each of the imaging areas in the two original images by the second number of pixels vertically, the processor is configured to call the executable instructions stored in the memory to perform at least one of the following:
in response to that the first difference value is greater than 0, horizontally move the imaging area in one of the two original images by the first number of pixels in a first direction towards the imaging area in the other one of the two original images, and horizontally move the imaging area in the other one of the two original images by the first number of pixels in a direction opposite to the first direction;
in response to that the first difference value is less than 0, horizontally move the imaging area in the one of the two original images by the first number of pixels in a second direction away from the imaging area in the other one of the two original images, and horizontally move the imaging area in the other one of the two original images by the first number of pixels in a direction opposite to the second direction;
in response to that the second difference value is greater than 0, vertically move the imaging area in the one of the two original images by the second number of pixels in a third direction towards the imaging area in the other one of the two original images, and vertically move the imaging area in the other one of the two original images by the second number of pixels in a direction opposite to the third direction; or
in response to that the second difference value is less than 0, vertically move the imaging area in the one of the two original images by the second number of pixels in a fourth direction away from the imaging area in the other one of the two original images, and vertically move the imaging area in the other one of the two original images by the second number of pixels in a direction opposite to the fourth direction.

15. The device of claim 9, the processor is further configured to call the executable instructions stored in the memory to:
determine a second parallax of the target object in the imaging areas of the two original images according to the adjusted positions of the imaging areas; and
in response to that the second parallax is consistent with the preset parallax, determine that the adjusted positions of the imaging areas meet a preset parallax correction requirement.

16. The device of claim 9, after determining the target images, the processor is further configured to call the executable instructions stored in the memory to:
perform detection for a target task based on the target images.

17. A non-transitory computer-readable storage medium having stored thereon a computer program which is configured to perform a method for parallax correction, the method comprising:
acquiring, by a binocular photographing device, two original images both containing a target object;
determining a first parallax of the target object in imaging areas, each in a respective one of the two original images;
adjusting positions of the imaging areas in the two original images according to the first parallax and a preset parallax; and
determining target images based on the imaging areas having the adjusted positions.

18. The non-transitory computer-readable storage medium of claim 17, determining the first parallax of the target object in the imaging areas, each in the respective one of the two original images comprises:
determining a target pixel at a preset position of the target object among a plurality of pixels corresponding to the target object in each of the two original images;
determining a coordinate value corresponding to the target pixel in each of the imaging areas in the two original images; and
taking a difference value between a coordinate value corresponding to the target pixel in the imaging area in one of the two original images and a coordinate value corresponding to the target pixel in the imaging area in the other one of the two original images as the first parallax of the target object in the imaging areas in the two original images.

19. The non-transitory computer-readable storage medium of claim 17, wherein adjusting the positions of the imaging areas in the two original images according to the first parallax and the preset parallax comprises:
determining a difference value between the preset parallax and the first parallax; and
adjusting the positions of the imaging areas in the two original images according to the difference value between the preset parallax and the first parallax.

20. The non-transitory computer-readable storage medium of claim 19, wherein the difference value between the preset parallax and the first parallax comprises a first difference value in a horizontal direction and a second difference value in a vertical direction; and
adjusting the positions of the imaging areas in the two original images according to the difference value between the preset parallax and the first parallax comprises:
determining a first number of pixels according to the first difference value, and determining a second number of pixels according to the second difference value; and
moving each of the imaging areas in the two original images by the first number of pixels horizontally, and moving each of the imaging areas in the two original images by the second number of pixels vertically.
